(19) United States
(12) Patent Application Publication
(10) Pub. No.: US 2024/0383198 A1
(43) Pub. Date: Nov. 21, 2024

(54) Molding Stage And Three-Dimensional Molding Method

(71) Applicant: SEIKO EPSON CORPORATION, Tokyo (JP)

(72) Inventor: Keitaro HASHIZUME, Shiojiri (JP)

(21) Appl. No.: 18/666,981

(22) Filed: May 17, 2024

(30) Foreign Application Priority Data
May 19, 2023 (JP) 2023-082820

(51) Int. Cl. B29C 64/245; B29C 64/118; B29C 64/241; B33Y 10/00; B33Y 30/00

(52) U.S. Cl. CPC B29C 64/245; B29C 64/118; B29C 64/241; B33Y 10/00; B33Y 30/00

(57) ABSTRACT

A molding stage includes a molding surface on which a molding material is deposited, wherein the molding surface includes a plurality of grooves having a predetermined arc degree formed along a circumference of one circle in a plan view of the molding surface, each of the grooves inclines in a direction in which a depth from the molding surface becomes deeper toward a first direction in the plan view, and includes a first portion having a first depth, and a second portion having a second depth deeper than the first depth, and in a cross-sectional view of the groove cut along a straight line passing through a center of the circle, among opening widths of openings on the molding surface, a first opening width which is an opening width in the first portion is larger than a second opening width which is the opening width in the second portion.

The present application is based on, and claims priority from JP Application Serial Number 2023-082820, filed May 19, 2023, the disclosure of which is hereby incorporated by reference herein in its entirety.

### BACKGROUND

### 1. Technical Field

The present disclosure relates to a molding stage and a three-dimensional molding method.

### 2. Related Art

In the past, there has been known a three-dimensional molding apparatus capable of shaping a three-dimensional molding object on a molding stage. JP-A-2017-200727 discloses, as an example of a molding stage, a stage including an upper plate in which through holes are formed and a lower plate having protruding parts to be inserted into the through holes. At the time of shaping, the protruding parts protrude from an upper surface of the upper plate to thereby enhance a fixing property between the molding stage and the three-dimensional molding object. After the shaping, the protruding parts are retracted below the upper surface of the upper plate, and thus, the three-dimensional molding object can be separated from the molding stage. JP-A-2017-200727 discloses a configuration in which the through holes and the protruding parts are inclined with respect to a horizontal surface.

JP-A-2017-200727 is an example of the related art.

In the molding stage disclosed in JP-A-2017-200727, the inclination directions of all the through holes are uniform. When viewed in cross section, there are a place where an angle formed between a circumference of one of the protruding parts and the horizontal surface is an acute angle and a place where that angle is an obtuse angle. When the inclination directions of all the through holes are uniform, the direction of the place where the angle formed between the circumference of the protruding part and the horizontal surface is the obtuse angle becomes uniform in all the through holes. There is room for improvement in related-art molding stages.

### SUMMARY

A molding stage includes a molding surface on which a molding material to be used in three-dimensional molding is deposited, wherein the molding surface includes a plurality of grooves having a predetermined arc degree formed along a circumference of one circle in a plan view of the molding surface, each of the grooves inclines in a direction in which a depth from the molding surface becomes deeper toward a first direction in the plan view, and includes a first portion in which the depth is a first depth, and a second portion in which the depth is a second depth deeper than the first depth, and in a cross-sectional view of the groove cut along a straight line passing through a center of the circle, among opening widths of openings on the molding surface, a first opening width which is the opening width in the first portion is larger than a second opening width which is the opening width in the second portion.

A three-dimensional molding method of shaping a three-dimensional molding object with the molding material on the molding stage described above includes applying the molding material to the molding surface with a nozzle configured to discharge the molding material while changing, in a plan view, a position of the nozzle with respect to the molding stage in the first direction along the circumference of the one circle, and changing a rotational position of the molding material with respect to the molding stage in a second direction opposite to the first direction taking the center of the one circle as a rotational axis in the plan view of the molding surface when separating the molding material from the molding stage.

### BRIEF DESCRIPTION OF THE DRAWINGS

FIG. 1 is a diagram illustrating a configuration of a three-dimensional molding apparatus.

FIG. 2 is a perspective view showing a screw.

FIG. 3 is a plan view showing a barrel.

FIG. 4 is a perspective view showing a molding stage.

FIG. 5 is a plan view showing the molding stage.

FIG. 6 is a perspective view illustrating grooves of the molding stage.

FIG. 7 is a cross-sectional view along the line A-A in FIG. 5.

FIG. 8 is a cross-sectional view along the line B-B in FIG. 5.

### DESCRIPTION OF EMBODIMENTS

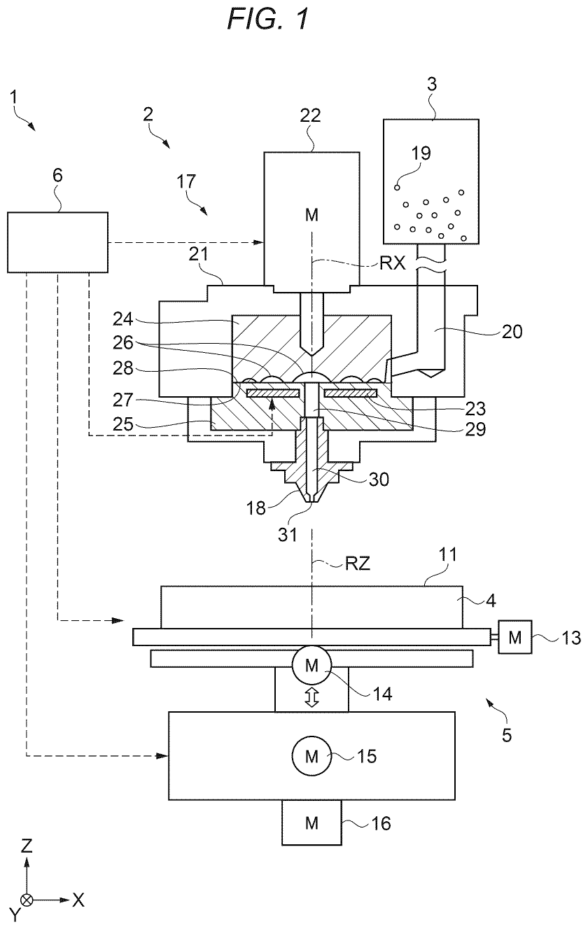

As shown in FIG. 1, a three-dimensional molding apparatus 1 includes a discharge unit 2, a supply device 3, a molding stage 4, a moving mechanism unit 5, and a control unit 6. The three-dimensional molding apparatus 1 is capable of changing a relative position between the discharge unit 2 and the molding stage 4 while discharging a molding material from the discharge unit 2 toward the molding stage 4. The relative position between the discharge unit 2 and the molding stage 4 is determined by moving the molding stage 4 with the moving mechanism unit 5. The relative position between the discharge unit 2 and the molding stage 4 can also be realized by moving the discharge unit 2. Furthermore, the relative position between the discharge unit 2 and the molding stage 4 can also be realized by moving both the molding stage 4 and the discharge unit 2.

The operation of the three-dimensional molding apparatus 1 is controlled by the control unit 6. The three-dimensional molding apparatus 1 is capable of shaping the three-dimensional molding object having a desired shape on a molding surface 11 of the molding stage 4. The “surface” as in the molding surface 11 includes not only a surface formed only of planes but also a surface that can be grasped as a surface occupying a certain region. The surface may be, for example, a surface with asperity. Note that shaping a three-dimensional molding object may be referred to as three-dimensional molding. The molding material is also referred to as a molten material in some cases.

In FIG. 1, an X axis, a Y axis, and a Z axis are illustrated. The X axis, the Y axis, and the Z axis are coordinate axes orthogonal to each other. In the drawings described hereinafter, the X axis, the Y axis, and the Z axis are illustrated as necessary. In this case, the X axis, the Y axis, and the Z axis in each drawing correspond to the X axis, the Y axis, and the Z axis in FIG. 1. FIG. 1 shows a state in which the three-dimensional molding apparatus 1 is disposed on an X-Y plane defined by the X axis and the Y axis. In the present embodiment, a state in which the three-dimensional molding apparatus 1 is disposed on the X-Y plane in a state in which the X-Y plane coincides with a horizontal plane corresponds to a use state of the three-dimensional molding apparatus 1. A posture of the three-dimensional molding apparatus 1 when the three-dimensional molding apparatus 1 is disposed on the X-Y plane that coincides with the horizontal plane is called a use posture of the three-dimensional molding apparatus 1.

In some cases, the X axis, the Y axis, and the Z axis are described in the drawings and descriptions showing an element or a unit of the three-dimensional molding apparatus 1. In this case, the X axis, the Y axis, and the Z axis mean the X axis, the Y axis, and the Z axis in a state where the element or the unit is incorporated in the three-dimensional molding apparatus 1. Further, a posture of each of the elements or the unit in the use posture of the three-dimensional molding apparatus 1 is called the use posture of that element or that unit. Further, in the following descriptions of the three-dimensional molding apparatus 1, the elements, the units, and so on, they are described in their respective use postures unless otherwise specified.

When the three-dimensional molding apparatus 1 is actually used, it is sufficient for the horizontal plane to be a substantially horizontal plane. The expression of “substantially horizontal” may include some inclination in an allowable inclination range, for example, with regard to the plane on which the three-dimensional molding apparatus 1 is placed when the three-dimensional molding apparatus 1 is used. For this reason, the substantially horizontal surface is not limited to a surface of, for example, a surface plate formed with high accuracy. The substantially horizontal surface includes various surfaces such as a desk, a table, a shelf, and a floor on which the three-dimensional molding apparatus 1 is placed when the three-dimensional molding apparatus 1 is used. A vertical direction is not limited to a direction strictly parallel to the gravitational direction, and includes a perpendicular direction with respect to the substantially horizontal plane. Therefore, when the substantially horizontal plane is a surface of, for example, a desk, a table, a shelf, a floor, or the like, the vertical direction means a perpendicular direction with respect to such a surface.

Arrows are given to the X axis, the Y axis, and the Z axis. In each of the X axis, the Y axis, and the Z axis, the direction of the arrow indicates a positive (+) direction, and the direction opposite to the direction of the arrow indicates a negative (−) direction. The Z axis is an axis orthogonal to the X-Y plane. In the use state of the three-dimensional molding apparatus 1, the +Z direction is a vertically upward direction. In the use state of the three-dimensional molding apparatus 1, the −Z direction is a vertically downward direction in FIG. 1. Viewing the X-Y plane in the −Z direction is called a plan view.

The molding stage 4 is capable of displacing along each of the X axis, the Y axis, and the Z axis by being driven by the moving mechanism unit 5. The molding stage 4 is capable of reciprocating along the X axis by being driven by the moving mechanism unit 5. The molding stage 4 is capable of reciprocating along the Y axis by being driven by the moving mechanism unit 5. The molding stage 4 is capable of reciprocating along the Z axis by being driven by the moving mechanism unit 5. The molding stage 4 is rotatable centering on a rotational axis RZ by being driven by the moving mechanism unit 5. The rotational axis RZ is an axis extending along the Z axis.

The moving mechanism unit 5 includes an X motor 13, a Y motor 14, a Z motor 15, and a θ motor 16. Driving of the X motor 13, the Y motor 14, the Z motor 15, and the θ motor 16 is controlled by the control unit 6. The moving mechanism unit 5 moves the molding stage 4 along the X axis with driving force of the X motor 13. The moving mechanism unit 5 moves the molding stage 4 along the Y axis with driving force of the Y motor 14. The moving mechanism unit 5 moves the molding stage 4 along the Z axis with driving force of the Z motor 15. The moving mechanism unit 5 rotates the molding stage 4 centering on the rotational axis RZ with driving force of the θ motor 16.

The discharge unit 2 includes a plasticizing unit 17 and a nozzle 18. The plasticizing unit 17 melts a granular material 19 as a raw material of the molding material to form the molding material. The nozzle 18 discharges the molding material. The supply device 3 supplies the granular material 19 to the discharge unit 2. The granular material 19 is a resin material granulated. The granular material 19 also includes a pellet-shaped material or a powdery material. The granular material 19 supplied from the supply device 3 to the discharge unit 2 is supplied to the plasticizing unit 17 via a supply path 20.

The plasticizing unit 17 includes a screw case 21, a drive motor 22, heaters 23, a screw 24, and a barrel 25. The plasticizing unit 17 plasticizes at least a part of the material supplied from the supply path 20 to generate a paste-like molding material having fluidity, and supplies the molded material to the nozzle 18. The term “plasticization” means that heat is applied to a material having thermal plasticity to melt the material. The term “melt” means not only heating the material having the thermal plasticity to a temperature equal to or higher than a melting point into a liquid, but also heating the material having the thermal plasticity to a temperature equal to or higher than a glass transition point to thereby soften the material and develop the fluidity. Note that the screw 24 in the present embodiment is formed of a flat screw.

The screw case 21 is a chassis for housing the screw 24. The barrel 25 is fixed to a lower surface of the screw case 21. The screw 24 is housed in a space surrounded by the screw case 21 and the barrel 25. The drive motor 22 is fixed to an upper surface of the screw case 21. The screw 24 has a substantially cylindrical shape in which a height in a direction along the Z axis is smaller than a diameter. The screw 24 has a groove forming surface 27 on which screw grooves 26 are formed on a surface facing the barrel 25. Specifically, the groove forming surface 27 is opposed to a screw opposed surface 28 of the barrel 25. The screw 24 is configured to be rotatable about the central axis RX as a rotation axis.

The drive motor 22 is located at the +Z direction side of the screw 24. The drive motor 22 is coupled to a surface at an opposite side to the groove forming surface 27 of the screw 24. The drive motor 22 generates power for rotating the screw 24. The screw 24 rotates centering on the central axis RX with the power from the drive motor 22. Driving of the drive motor 22 is controlled by the control unit 6. The drive motor 22 is not required to directly be coupled to the screw 24. For example, the screw 24 and the drive motor 22 may be coupled to each other via a speed reducer.

The barrel 25 is located at the −Z direction side of the screw 24. The barrel 25 is disposed to be opposed to the groove forming surface 27 of the screw 24. The barrel 25 has the screw opposed surface 28 opposed to the groove forming surface 27 of the screw 24. The barrel 25 is provided with a communication hole 29 on the central axis RX of the screw 24. The molding material generated by the plasticizing unit 17 is supplied to the nozzle 18 via the communication hole 29. The heaters 23 are embedded in the barrel 25. The barrel 25 is provided with the two heaters 23 shaped like rods extending along the Y axis. The heaters 23 heat the material supplied between the screw 24 and the barrel 25. Driving of the heaters 23 is controlled by the control unit 6.

The nozzle 18 is disposed at the −Z direction side of the barrel 25. The nozzle 18 is provided with a nozzle flow path 30 and a nozzle hole 31. The nozzle flow path 30 is a flow channel disposed in the nozzle 18. The nozzle flow path 30 is communicated with the communication hole 29 of the barrel 25. The nozzle hole 31 opens in an end portion at the −Z direction side of the nozzle 18. The nozzle hole 31 is the end portion at the −Z direction side of the nozzle flow path 30. The nozzle hole 31 includes a portion which is disposed in the end portion at the −Z direction side of the nozzle flow path 30, and in which the flow channel cross section is reduced. The molding material supplied from the plasticizing unit 17 to the nozzle flow path 30 is discharged from the nozzle hole 31. In the present embodiment, the opening shape of the nozzle hole 31 is a circular shape. Note that the opening shape of the nozzle hole 31 is not limited to the circular shape, and may be an ellipse, a rectangle, a polygon other than a rectangle, or the like.

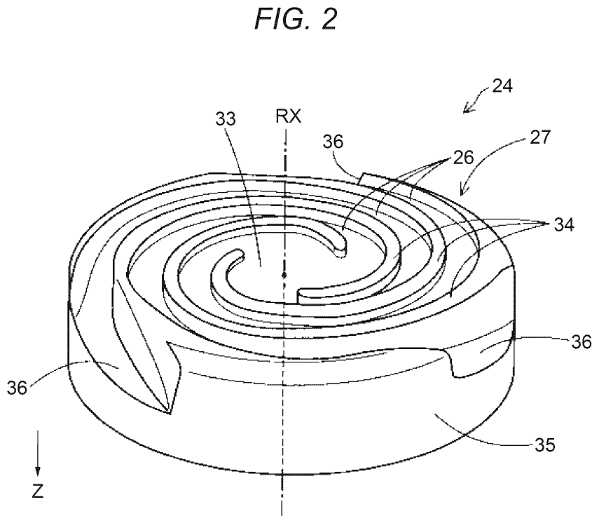

As shown in FIG. 2, the screw 24 has the groove forming surface 27. The screw grooves 26 are provided to the groove forming surface 27. A screw center portion 33 which is a center portion of the groove forming surface 27 of the screw 24 is configured as a recess to which one ends of the screw grooves 26 are connected. The screw center portion 33 is opposed to the communication hole 29 of the barrel 25 shown in FIG. 1. The screw center portion 33 crosses the central axis RX.

As shown in FIG. 2, the screw grooves 26 of the screw 24 each constitute a so-called scroll groove. The screw grooves 26 each extend spirally from the screw center portion 33 toward the outer periphery of the screw 24 drawing an arc. The screw grooves 26 may each be configured to extend in an involute curve shape or a spiral shape. The groove forming surface 27 is provided with protruding line portions 34. The protruding line portions 34 form sidewall portions of the screw grooves 26. The protruding line portions 34 extend along the screw grooves 26. The screw grooves 26 continue to material inlets 36 provided to a side surface 35 of the screw 24. The material inlets 36 are each a portion that receives the material supplied via the supply path 20 shown in FIG. 1.

FIG. 2 shows an example of the screw 24 having the three screw grooves 26 and the three protruding line portions 34. The number of the screw grooves 26 and the protruding line portions 34 provided to the screw 24 is not limited to three. The screw 24 may be provided with just one screw groove 26, or may be provided with two or more screw grooves 26. Further, any number of protruding line portions 34 may be provided in accordance with the number of the screw grooves 26.

FIG. 2 shows an example of the screw 24 in which the material inlets 36 are formed at three positions. The number of the material inlets 36 provided to the screw 24 is not limited to three. The screw 24 may be provided with the material inlet 36 at just one place, or may be provided with the material inlets 36 at two or more places.

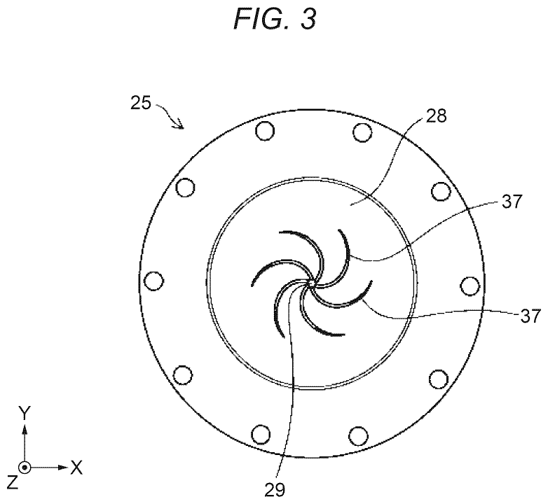

As shown in FIG. 3, the barrel 25 has the screw opposed surface 28. The communication hole 29 is formed at the center of the screw opposed surface 28. A plurality of guide grooves 37 are formed on the periphery of the communication hole 29 in the screw opposed surface 28. Each of the guide grooves 37 has one end coupled to the communication hole 29 and extends spirally from the communication hole 29 toward the outer periphery of the screw opposed surface 28. Each of the guide grooves 37 has a function of guiding the molding material to the communication hole 29. In order to make the molding material efficiently reach the communication hole 29, it is preferable to provide the guide grooves 37 to the barrel 25, but the guide groove 37 are not required to be formed.

The control unit 6 is formed of a computer including one or more processors, a main storage device, and an input and output interface for inputting and outputting signals from and to the outside. The control unit 6 exerts various functions by executing programs and commands read into the main storage device with the processor. For example, the control unit 6 exerts a function of executing three-dimensional molding processing. Note that the control unit 6 may be configured with a combination of a plurality of circuits instead of the computer.

The three-dimensional molding processing refers to processing for shaping a three-dimensional molding object. The three-dimensional molding processing may be referred to simply as shaping processing. In the three-dimensional molding processing, the control unit 6 controls the plasticizing unit 17 and the moving mechanism unit 5 to discharge the molding material from the discharge unit 2 to the molding surface 11 to deposit the molding material on the molding surface 11. More specifically, the control unit 6 shapes a three-dimensional molding object by forming layers of the molding material while solidifying the molding material discharged onto the molding surface 11. The solidification of the molding material means that the molding material discharged from the discharge unit 2 loses fluidity. In the present embodiment, the molding material is thermally shrunk by being cooled, and loses fluidity to be solidified.

In the three-dimensional molding processing, the control unit 6 in the present embodiment shapes the three-dimensional molding object in accordance with molding data. For example, the control unit 6 generates the molding data by dividing the three-dimensional molding object on the shape data representing the shape of the three-dimensional molding object created using three-dimensional CAD software or three-dimensional CG software into layers having a predetermined thickness. In this case, the control unit 6 can acquire the shape data from, for example, an external computer coupled to the three-dimensional molding apparatus 1. Further, for example, the control unit 6 may directly acquire the molding data from an external computer or the like without generating the molding data. Further, for example, the molding data may be generated by slicer software or the like.

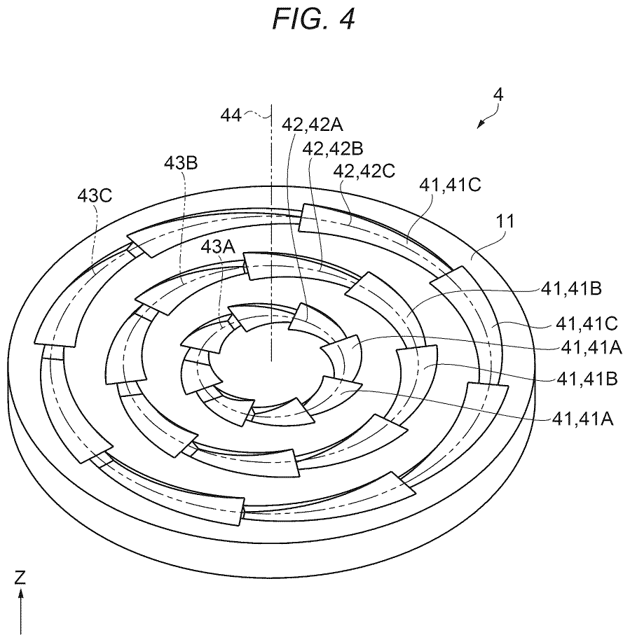

As shown in FIG. 4, the molding stage 4 has the molding surface 11. The molding surface 11 faces to the +Z direction. A plurality of grooves 41 are provided to the molding surface 11. Each of the plurality of grooves 41 is formed in a direction recessed from the molding surface 11 toward the −Z direction. The plurality of grooves 41 constitute three arrays 42. In each of the three arrays 42, the plurality of grooves 41 are arranged annularly. When the three arrays 42 are individually identified, the three arrays 42 are denoted by a first array 42A, a second array 42B, and a third array 42C, respectively. In the first array 42A, the plurality of grooves 41 are arranged annularly. In the second array 42B, the plurality of grooves 41 are arranged annularly. In the third array 42C, the plurality of grooves 41 are arranged annularly.

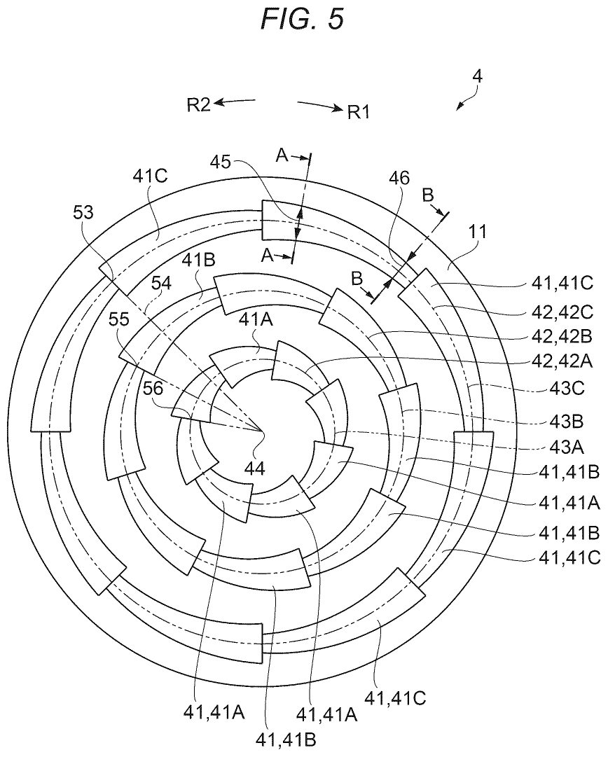

As shown in FIG. 5, the first array 42A is formed along a circumference of a first circle 43A. The second array 42B is formed along a circumference of a second circle 43B. The third array 42C is formed along a circumference of a third circle 43C. The first circle 43A, the second circle 43B, and the third circle 43C are concentric circles centered on a central axis 44 of the molding stage 4. The central axis 44 coincides with the rotational axis RZ of the molding stage 4. Any one of the first circle 43A, the second circle 43B, and the third circle 43C corresponds to a primary circle. Remaining one of the first circle 43A, the second circle 43B, and the third circle 43C corresponds to a secondary circle.

The second circle 43B is located outside the first circle 43A. The third circle 43C is located outside the second circle 43B. Among the plurality of grooves 41, each of the plurality of grooves 41 constituting the first array 42A is referred to as a first array groove 41A. Among the plurality of grooves 41, each of the plurality of grooves 41 constituting the second array 42B is referred to as a second array groove 41B. Among the plurality of grooves 41, each of the plurality of grooves 41 constituting the third array 42C is referred to as a third array groove 41C. The plurality of grooves 41 constituting the array 42 corresponding to the primary circle among the first circle 43A, the second circle 43B, and the third circle 43C corresponds to first grooves. The plurality of grooves 41 constituting the array 42 corresponding to the secondary circle among the first circle 43A, the second circle 43B, and the third circle 43C corresponds to second grooves.

In the present embodiment, the number of grooves 41 constituting each of the arrays 42 is equal among the three arrays 42. That is, the grooves 41 constituting the first array 42A, the grooves 41 constituting the second array 42B, and the grooves 41 constituting the third array 42C are equal in number to each other. The first array groove 41A extends along the circumference of the first circle 43A. That is, the first array groove 41A extends along an arc of the first circle 43A. The second array groove 41B extends along the circumference of the second circle 43B. That is, the second array groove 41B extends along an arc of the second circle 43B. The third array groove 41C extends along the circumference of the third circle 43C. That is, the third array groove 41C extends along an arc of the third circle 43C.

In the plan view, the lengths of the first array grooves 41A are equal to each other among the plurality of first array grooves 41A. The length of the arc of the circumference of the first circle 43A overlapping one first array groove 41A is equal among the plurality of first array grooves 41A. That is, a plane angle that defines an arc overlapping one first array groove 41A is equal among the plurality of first array grooves 41A. In the first array 42A, it may also be expressed that the plurality of grooves 41 are arranged at the same angular pitch. In the present embodiment, the length of an arc of the circumference of the first circle 43A that overlaps one first array groove 41A is the length of one of arcs obtained when the circumference of the first circle 43A is divided into eight equal parts. The first array grooves 41A have the same arc degree along the circumference of the first circle 43A.

In the plan view, the lengths of the second array grooves 41B are equal to each other among the plurality of second array grooves 41B. The length of the arc of the circumference of the second circle 43B overlapping one second array groove 41B is equal among the plurality of second array grooves 41B. That is, a plane angle that defines an arc overlapping one second array groove 41B is equal among the plurality of second array grooves 41B. In the second array 42B, it may also be expressed that the plurality of grooves 41 are arranged at the same angular pitch. In the present embodiment, the length of an arc of the circumference of the second circle 43B that overlaps one second array groove 41B is the length of one of arcs obtained when the circumference of the second circle 43B is divided into eight equal parts. The second array grooves 41B have the same arc degree along the circumference of the second circle 43B.

In the plan view, the lengths of the third array grooves 41C are equal to each other among the plurality of third array grooves 41C. The length of the arc of the circumference of the third circle 43C overlapping one third array groove 41C is equal among the plurality of third array grooves 41C. That is, a plane angle that defines an arc overlapping one third array groove 41C is equal among the plurality of third array grooves 41C. In the third array 42C, it may also be expressed that the plurality of grooves 41 are arranged at the same angular pitch. In the present embodiment, the length of an arc of the circumference of the third circle 43C overlapping one third array groove 41C is the length of one of arcs obtained when the circumference of the third circle 43C is divided into eight equal parts. The third array grooves 41C have the same arc degree along the circumference of the third circle 43C. Therefore, in the present embodiment, all the grooves 41 have the same predetermined arc degree. In addition, in the present embodiment, in each of the arrays 42, two grooves 41 adjacent to each other in the circumferential direction are connected to each other. That is, there is no gap between two grooves 41 adjacent to each other in the circumferential direction.

The number of the arrays 42 is not limited to three. The number of the arrays 42 may be one or two. Further, the number of the arrays 42 may be more than three. The number of the grooves 41 constituting one array 42 is not limited to eight. The number of the grooves 41 constituting one array 42 may be any number equal to or greater than one. In addition, in each of the arrays 42, a configuration in which a gap is provided between two grooves 41 adjacent to each other in the circumferential direction may be adopted.

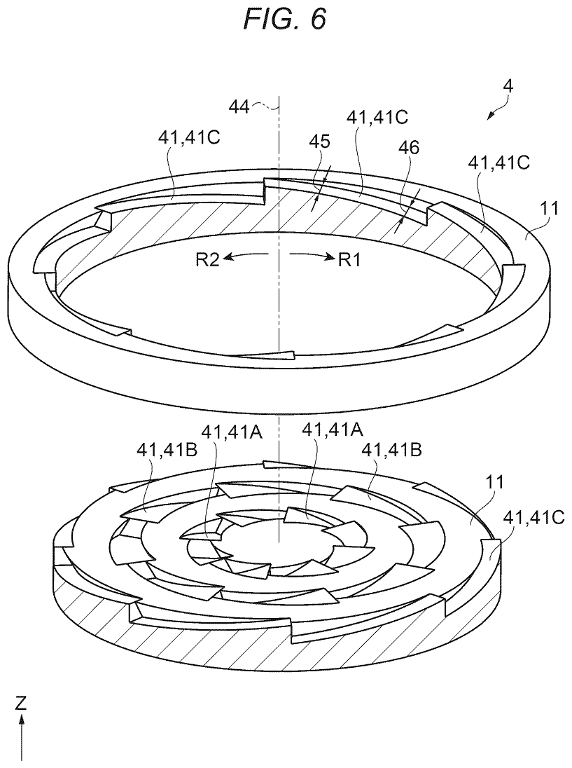

FIG. 6 is a perspective view illustrating the grooves 41 of the molding stage 4. FIG. 6 shows a state in which the molding stage 4 is cut with the third circle 43C shown in FIG. 5. Each of the grooves 41 is inclined. Each of the grooves 41 is inclined in a direction in which the depth from the molding surface 11 increases toward a first direction R1 in the plan view. The first direction R1 is a clockwise direction about the central axis 44 in the plan view of the molding surface 11. An opposite direction to the first direction R1 is a second direction R2. The second direction R2 is a counterclockwise direction about the central axis 44 in the plan view of the molding surface 11. Each of the grooves 41 includes a first portion 45 having a first depth from the molding surface 11 and a second portion 46 having a second depth deeper than the first depth. The inclination direction of the plurality of grooves 41 may be a direction in which the depth from the molding surface 11 increases toward the second direction R2.

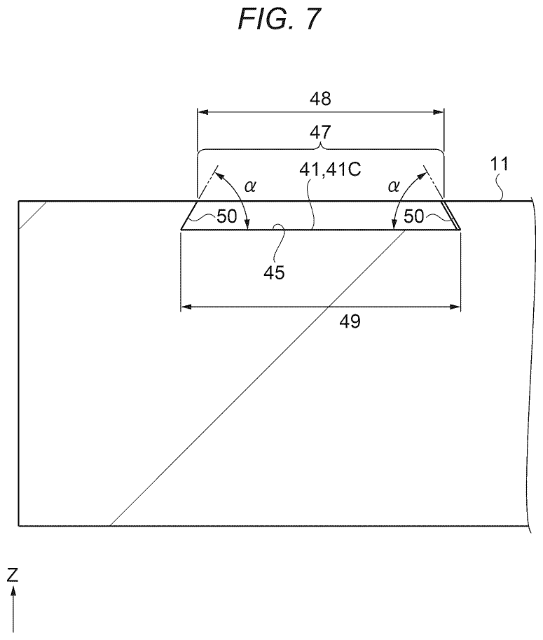

FIG. 7 is a cross-sectional view along the line A-A in FIG. 5. FIG. 7 corresponds to a cross-sectional view of the first portion 45 of the third array groove 41C when being cut along a straight line passing through the central axis 44. As shown in FIG. 7, the third array groove 41C has an opening 47 that opens on the molding surface 11. The opening 47 in the first portion 45 has a first opening width 48. A bottom width 49 of the groove 41 in the first portion 45 is larger than the first opening width 48. An inner wall 50 of each of the grooves 41 is inclined toward the inside of that groove 41 as proceeding from the bottom of that groove 41 toward the molding surface 11. The angle α between the inner wall 50 and a horizontal plane is an acute angle. That is, the inner wall 50 of each of the grooves 41 is formed to have a reversely tapered shape. Each of the grooves 41 is a so-called dovetail groove.

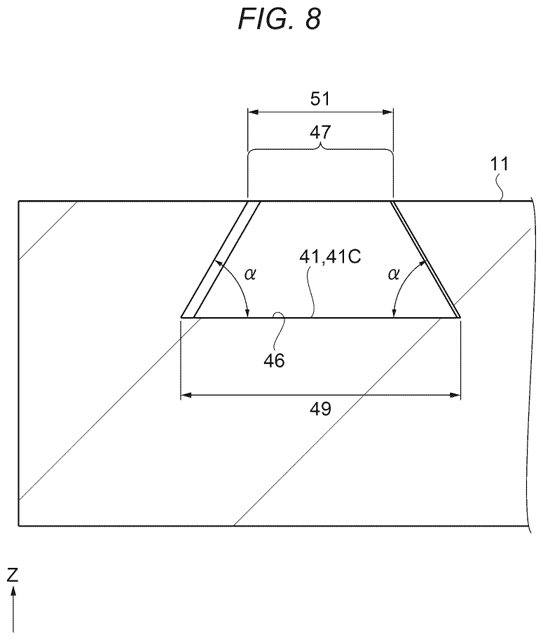

FIG. 8 is a cross-sectional view along line B-B in FIG. 5. FIG. 8 corresponds to a cross-sectional view of the second portion 46 of the third array groove 41C when being cut along a straight line passing through the central axis 44. As shown in FIG. 8, the opening 47 in the second portion 46 of the third array groove 41C has a second opening width 51. Also in the second portion 46, the bottom width 49 of the groove 41 is larger than the second opening width 51. In the present embodiment, the first opening width 48 shown in FIG. 7 is larger than the second opening width 51 shown in FIG. 8. In the present embodiment, the angle α between the inner wall 50 and the horizontal plane is set to 10 through 60 degrees. When the angle α is less than 10 degrees, it is difficult to form the groove 41. When the angle α exceeds 60 degrees, it is difficult to secure fixing force of the molding object described below. Further, in the present embodiment, the bottom width 49 of the groove 41 in the second portion 46 is narrower than the bottom width 49 of the groove 41 in the first portion 45. In the present embodiment, the bottom width 49 of the groove 41 gradually decreases in the first direction R1.

Further, in the present embodiment, as shown in FIG. 5, a straight line 54 passing through a first place 53 and the central axis 44 does not overlap a second place 55. The straight line 54 does not overlap a third place 56. The first place 53 is a place in the third array groove 41C having the shallowest depth from the molding surface 11. The second place 55 is a place in the second array groove 41B having the shallowest depth from the molding surface 11. The third place 56 is a place in the first array groove 41A having the shallowest depth from the molding surface 11. Note that the straight line 54 may overlap the second place 55. Further, the straight line 54 may overlap the third place 56. Further, the straight line 54 may overlap the second place 55 and the third place 56.

The three-dimensional molding apparatus 1 having the configuration described above is capable of shaping the molding object on the molding surface 11 of the molding stage 4 by discharging the molding material from the nozzle hole 31 toward the molding stage 4. At this time, in the three-dimensional molding apparatus 1, it is possible to shape the molding objects having various three-dimensional shapes by changing the relative positions between the discharge unit 2 and the molding stage 4 while discharging the molding material from the nozzle hole 31. The molding material discharged from the nozzle hole 31 to the molding surface 11 of the molding stage 4 enters the plurality of grooves 41. When the molding material that has entered the plurality of grooves 41 is solidified, the position of the solidified portion along the Z axis is regulated by the sidewall of the groove 41. Therefore, it is possible to prevent the molding object formed on the molding stage 4 from moving toward the +Z direction.

According to the molding stage 4, the angle α between the inner wall 50 and the horizontal plane is an acute angle. Since the plurality of grooves 41 are formed along the circumference, portions where the angle α is an acute angle are arranged in various directions with the central axis 44 as a starting point in the plan view. Accordingly, it is easy to equalize the fixing force of the molding object in various directions. Therefore, it is possible to more stably fix the molding object compared to when the portions where the angle α is an acute angle are eccentrically located in a specific direction.

According to the molding stage 4, the plurality of grooves 41 having a predetermined arc degree are formed on the molding surface 11 along the circumference of each of the arrays 42. Each of the plurality of grooves 41 is inclined in a direction in which the depth from the molding surface 11 increases toward the first direction R1 in the plan view. By the molding material deposited on the molding surface 11 entering the second portion 46 of the groove 41, it is possible to fix the molding object to the molding stage 4. Further, by rotating the molding object with respect to the molding stage 4 in a direction in which the depth of the grooves 41 becomes shallow, it is possible to easily separate the molding object from the molding stage 4.

In the present embodiment, the first array 42A, the second array 42B, and the third array 42C concentrically arranged are formed. Therefore, the molding object can be fixed more stably compared to when any one of the first array 42A, the second array 42B, and the third array 42C is formed.

In the three-dimensional molding apparatus 1, when the molding material is applied to the molding surface 11 with the nozzle 18, it is preferable to apply the molding material while changing the position of the nozzle 18 in the first direction R1 in the plan view. Further, at this time, it is preferable to apply the molding material while changing the position of the nozzle 18 with respect to the molding stage 4 in the first direction R1 along the circumference of each of the first circle 43A, the second circle 43B, and the third circle 43C. According to the three-dimensional molding method, when the molding material is applied to the molding surface 11, the molding material discharged from the nozzle 18 can be applied from the side where the depth of the groove 41 is shallow toward the side where the depth is deep. Accordingly, it is easy to make the molding material enter the inside of the groove 41, and therefore, it is easy to fix the molding object to the molding stage 4.

Changing the position of the nozzle 18 with respect to the molding stage 4 in the first direction R1 can be achieved by moving the nozzle 18. The changing the position of the nozzle 18 with respect to the molding stage 4 in the first direction R1 can also be achieved by moving the molding stage 4. Furthermore, the changing the position of the nozzle 18 with respect to the molding stage 4 in the first direction R1 can also be achieved by moving both the nozzle 18 and the molding stage 4. Note that the shape of the nozzle hole 31 is not limited to a circle.

There can be adopted a method of rotating the molding surface 11 in the second direction R2 about the central axis 44 in the plan view when the molding material is applied to the molding surface 11. According to the three-dimensional molding method, when the molding material is applied to the molding surface 11, the molding material discharged from the nozzle 18 can be applied from the side where the depth of the groove 41 is shallow toward the side where the depth is deep.

Further, it is preferable to change the rotational position of the molding material with respect to the molding stage 4 in the second direction R2 with the central axis 44 as a rotational axis in the plan view of the molding surface 11 when the molding material is separated from the molding stage 4. According to the three-dimensional molding method, when the molding material is separated from the molding stage 4, it is possible to change the rotational position of the molding material with respect to the molding stage 4 in the second direction R2. Accordingly, the molding material located inside the groove 41 can be displaced from the deep side to the shallow side of the groove 41. As a result, the molding material can easily be separated from the molding stage 4.

Changing the position of the molding material with respect to the molding stage 4 in the second direction R2 can be achieved by rotating the molding material. The changing the position of the molding material with respect to the molding stage 4 in the second direction R2 can also be achieved by rotating the molding stage 4. Furthermore, the changing the position of the molding material with respect to the molding stage 4 in the second direction R2 can also be achieved by rotating both the molding material and the molding stage 4.

What is claimed is:

1. A molding stage comprising:
a molding surface on which a molding material to be used in three-dimensional molding is deposited, wherein
the molding surface includes a plurality of grooves having a predetermined arc degree formed along a circumference of one circle in a plan view of the molding surface,
each of the grooves inclines in a direction in which a depth from the molding surface becomes deeper toward a first direction in the plan view, and includes a first portion in which the depth is a first depth, and a second portion in which the depth is a second depth deeper than the first depth, and
in a cross-sectional view of the groove cut along a straight line passing through a center of the circle, among opening widths of openings on the molding surface, a first opening width which is an opening width in the first portion is larger than a second opening width which is the opening width in the second portion.

2. The molding stage according to claim 1, wherein
the one circle is a primary circle, and a plurality of the grooves are further formed along a circumference of a secondary circle that is concentric with the primary circle and different from the primary circle.

3. The molding stage according to claim 2, wherein
each of the grooves corresponding to the primary circle is defined as a first groove, each of the grooves corresponding to the secondary circle is defined as a second groove, and
a straight line passing through a first place where the depth is shallowest of the first groove and the center of the primary circle fails to overlap a second place where the depth is shallowest of the second groove in the plan view.

4. A three-dimensional molding method of shaping a three-dimensional molding object with the molding material on the molding stage according to claim 1, the three-dimensional molding method comprising:
applying the molding material to the molding surface with a nozzle configured to discharge the molding material while changing, in a plan view, a position of the nozzle with respect to the molding stage in the first direction along the circumference of the one circle; and
changing a rotational position of the molding material with respect to the molding stage in a second direction opposite to the first direction taking the center of the one circle as a rotational axis in the plan view of the molding surface when separating the molding material from the molding stage.

5. The three-dimensional molding method according to claim 4, wherein
when the molding material is applied to the molding surface, the molding surface is rotated in the second direction about the rotational axis in the plan view.
